(19) United States
(12) Patent Application Publication
(10) Pub. No.: US 2026/0018031 A1
(43) Pub. Date: Jan. 15, 2026

(54) NON-TRANSITORY COMPUTER READABLE MEDIUM, GAME APPARATUS, AND INFORMATION PROCESSING METHOD

(71) Applicant: CYGAMES, INC., Tokyo (JP)

(72) Inventors: Kentaro Sekiguchi, Tokyo (JP); Yu Hinai, Tokyo (JP); Seiji Kobayashi, Tokyo (JP)

(73) Assignee: CYGAMES, INC., Tokyo (JP)

(21) Appl. No.: 19/331,350

(22) Filed: Sep. 17, 2025

Related U.S. Application Data
(63) Continuation of application No. PCT/JP2024/008467, filed on Mar. 6, 2024.

(30) Foreign Application Priority Data
Mar. 20, 2023 (JP) 2023-044687

(51) Int. Cl. G07F 17/32

(52) U.S. Cl. CPC G07F 17/329; G07F 17/3262

(57) ABSTRACT

Provided is a non-transitory computer readable medium storing a program that causes a computer to execute: processing of setting a first period in a case where a predetermined condition is satisfied; processing of enabling reception of a first operation for acquiring a first right to obtain a first prize by spending a price in the first period; processing of giving the first prize to a player ID, based on a predetermined operation being input, after the first right has been acquired; processing of setting a second period, based on the first right being acquired; processing of enabling reception of a second operation for acquiring a second right to obtain a second prize by spending a price in the second period; and processing of giving the second prize to the player ID, based on a predetermined operation being input, after the second right has been acquired.

### CROSS REFERENCE TO RELATED APPLICATIONS

This application is a continuation application of International Application No. PCT/JP2024/008467, filed on Mar. 6, 2024, which claims priority to Japanese Patent Application No. 2023-044687, filed on Mar. 20, 2023, the entire contents of which are incorporated by reference herein.

### BACKGROUND ART

### Technical Field

The present invention relates to an information processing program, a game apparatus, and an information processing method.

An information processing system in which items, characters, and the like that are used in a game can be obtained by executing a lottery called a gacha for free or for a fee is known. For example, Patent Document 1 describes an information processing system that executes a lottery for a player who has just started a game by using a lottery table in which items and characters with high rarity values appear.

### CITATION LIST

### Patent Literature

Patent Document 1: JP 6960974 B

### SUMMARY OF INVENTION

### Technical Problem

With such information processing systems, a player may be able to execute a lottery that enables the player to obtain a special item, character, or the like only during a predetermined period. However, depending on the setting of the period in which the lottery can be executed, the player may be unable to execute the lottery, and the motivation of the player to play the game may decrease.

An object of the present invention is to provide an information processing program, a game apparatus, and an information processing method that can increase motivation to play a game.

### Solution to Problem

To solve the problems described above, provided is an information processing program that causes a computer to execute: processing of setting a first period in a case where a predetermined condition is satisfied; processing of enabling reception of a first operation for acquiring a right to obtain a first prize by spending a price in the first period; processing of giving the first prize to a player ID, based on a predetermined operation being input, after the right to obtain the first prize has been acquired; processing of setting a second period, based on the right to obtain the first prize being acquired; processing of enabling reception of a second operation for acquiring a right to obtain a second prize identical to or different from the first prize by spending a price in the second period; and processing of giving the second prize to the player ID, based on a predetermined operation being input, after the right to obtain the second prize has been acquired.

The information processing program may cause a computer to execute: processing of giving a right to obtain an initial prize identical to or different from the first prize without spending a price to the player ID in the first period; and processing of giving the initial prize to the player ID by exercising the right to obtain the initial prize, in which the processing of enabling reception of the first operation includes enabling reception of the first operation, based on the right to obtain the initial prize being exercised.

The information processing program may cause a computer to execute: processing of selecting a selection type most recently executed from among a plurality of selection types previously executed; and processing of referencing a determination table corresponding to the selected selection type and determining one from among a plurality of types of prizes via lottery, in which a prize determined via the lottery is given to the player ID as the initial prize, the first prize, or the second prize.

The predetermined condition may include a progress status of a game becoming a predetermined status.

To solve the problems described above, provided is a game apparatus implemented by one or more computers, the one or more computers executing: processing of setting a first period in a case where a predetermined condition is satisfied; processing of enabling reception of a first operation for acquiring a right to obtain a first prize by spending a price in the first period; processing of giving the first prize to a player ID, based on a predetermined operation being input, after the right to obtain the first prize has been acquired; processing of setting a second period, based on the right to obtain the first prize being acquired; processing of enabling reception of a second operation for acquiring a right to obtain a second prize identical to or different from the first prize by spending a price in the second period; and processing of giving the second prize to the player ID, based on a predetermined operation being input, after the right to obtain the second prize has been acquired.

To solve the problems described above, provided is an information processing method implemented by one or more computers, the one or more computers executing: processing of setting a first period in a case where a predetermined condition is satisfied; processing of enabling reception of a first operation for acquiring a right to obtain a first prize by spending a price in the first period; processing of giving the first prize to a player ID, based on a predetermined operation being input, after the right to obtain the first prize has been acquired; processing of setting a second period, based on the right to obtain the first prize being acquired; processing of enabling reception of a second operation for acquiring a right to obtain a second prize identical to or different from the first prize by spending a price in the second period; and processing of giving the second prize to the player ID, based on a predetermined operation being input, after the right to obtain the second prize has been acquired.

### Effects of Disclosure

According to the present invention, motivation to play a game can be increased.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3A is a diagram illustrating an example of a tutorial screen. FIG. 3B is a diagram illustrating an example of a my page screen. FIG. 3C is a diagram illustrating an example of a gacha screen.

FIGS. 4A to 4D are diagrams for describing a lottery table of “beginner festival”.

FIG. 5 is a first diagram illustrating an example of a beginner festival screen in “STEP 1”.

FIG. 6 is a diagram for describing the relationship between a sales period and an available period in each “STEP” of the “beginner festival”.

FIG. 7A is a diagram illustrating an example of a lottery result screen. FIG. 7B is a diagram illustrating an example of a lottery result confirmation screen.

FIG. 8 is a second diagram illustrating an example of the beginner festival screen in “STEP 1”.

FIG. 9 is a first diagram illustrating an example of the beginner festival screen in “STEP 2”.

FIG. 10 is a second diagram illustrating an example of the beginner festival screen in “STEP 2”.

FIG. 11 is a first diagram illustrating an example of the beginner festival screen in “STEP 3”.

FIG. 12 is a second diagram illustrating an example of the beginner festival screen in “STEP 3”.

FIG. 13A is a first diagram illustrating an example of an item obtainment screen. FIG. 13B is a second diagram illustrating an example of the item obtainment screen.

FIG. 14 is a diagram for describing a configuration of a memory in the player terminal and a function as a computer.

FIG. 15 is a diagram for describing a configuration of a memory in a server and a function as a computer.

FIG. 16 is a sequence diagram for describing basic processing of the player terminal and the server.

FIG. 17 is a flowchart for describing an example of beginner festival first management processing in the server.

FIG. 18 is a flowchart for describing an example of lottery processing in the server.

FIG. 19 is a flowchart for describing an example of beginner festival second management processing in the server.

### DESCRIPTION OF EMBODIMENTS

Hereinafter, an aspect of an embodiment of the present invention will be described in detail with reference to the accompanying drawings. Numerical values and the like described in the embodiment are merely examples for facilitating understanding, and do not limit the present invention unless otherwise specified. In this description and the drawings, elements having substantially the same function and configuration are denoted by the same reference numerals, and redundant description thereof will be omitted, and elements not directly relating to the present invention will not be illustrated.

### Overall Configuration of Information Processing System S

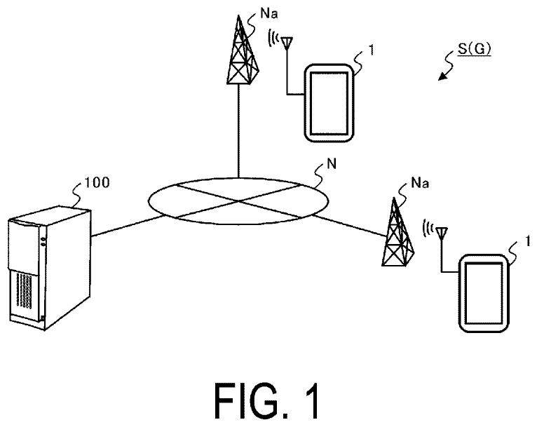

FIG. 1 is an explanatory diagram illustrating a schematic configuration of an information processing system S. The information processing system S is a so-called client-server system in which a player terminal 1 and a server 100 connect to a communication network N including a communication base station Na.

The player terminal 1 can establish communication with the server 100 via the communication network N. The player terminal 1 widely includes an electronic device that can establish wireless or wired communication connection with the server 100. Examples of the player terminal 1 include a smartphone, a mobile phone, a tablet device, a personal computer, a game console, and the like. In the present embodiment, a case where a smartphone is used as the player terminal 1 will be described.

The server 100 is communicatively connected to a plurality of player terminals 1. The server 100 accumulates various types of information (player information) for each player ID for identifying a player who plays the game. The server 100 updates the accumulated information and controls the progress of the game, based on the operation input from the player terminals 1.

The communication base station Na is connected to the communication network N and wirelessly exchanges information with the player terminal 1. The communication network N is constituted by a cellular network, an Internet network, a local area network (LAN), a dedicated line, or the like, and establishes a wireless or wired communication connection between the player terminal 1 and the server 100.

In the information processing system S of the present embodiment, the player terminals 1 and the server 100 function as a game apparatus G. The player terminal 1 and the server 100 share the function of game progress control. The game can be progressed through by cooperation between the player terminal 1 and the server 100.

### Hardware Configuration of Player Terminal 1 and Server 100

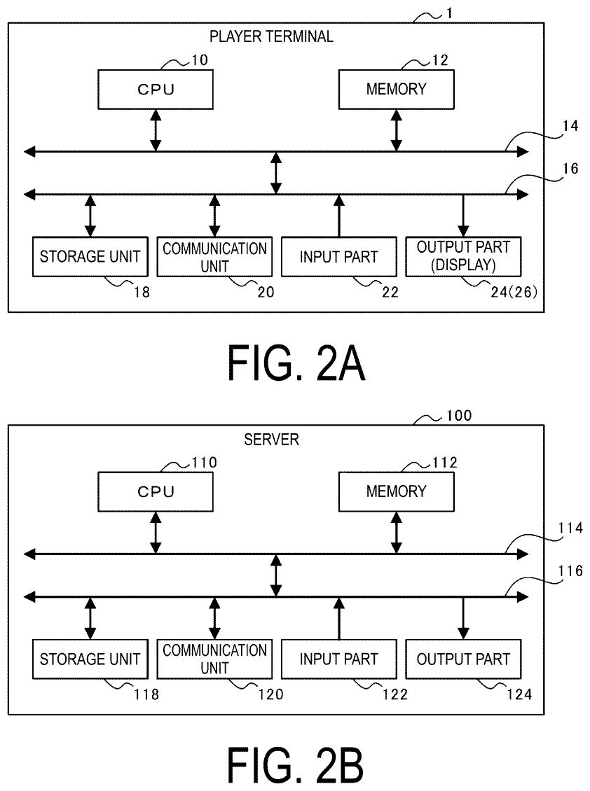

FIG. 2A is a diagram for describing a hardware configuration of the player terminal 1. FIG. 2B is a diagram illustrating a hardware configuration of the server 100. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 100 includes a CPU 110, a memory 112, a bus 114, an input/output interface 116, a storage unit 118, a communication unit 120, an input part 122, and an output part 124.

The configurations and functions of the CPU 110, the memory 112, the bus 114, the input/output interface 116, the storage unit 118, the communication unit 120, the input part 122, and the output part 124 of the server 100 are substantially the same as those of the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 100 will be omitted.

The CPU 10 operates a program stored in the memory 12 to control the progress of the game. The memory 12 is constituted by a read-only memory (ROM) or a random-access memory (RAM) and stores programs and various kinds of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various kinds of data and programs with the server 100 via the communication network N. In the player terminal 1, the programs or the like received from the server 100 are stored in the memory 12 or the storage unit 18.

The input part 22 includes, for example, a touch panel, a button, a keyboard, a mouse, a four-direction key, an analog controller, and the like for inputting operations (receiving operations) of the player. Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects audio from the player. That is, the input part 22 widely includes apparatuses that allow the player to identifiably input their intention.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

The information processing system S and the game apparatus G according to the present embodiment can be applied to any game genre. In other words, the content of the game to which the information processing system S and the game apparatus G of the present embodiment are applied is not particularly limited. Examples of games that may be provided by the information processing system S and the game apparatus G include a role-playing game (RPG), a shooting game, a nurture game, an action game, a sports game, a simulation game, and a puzzle game. However, the information processing system S and the game apparatus G are widely applicable and can be applied to games other than those described above.

In the present embodiment, a lottery called gacha can be executed. In the lottery, a prize, in other words, a reward, to be given to the player is determined. Here, a game content that can be used by the player in the game is given as a reward. Examples of the game content include a character, an item, and in-game currency. However, the rewards determined via lottery and the details of the game content are not particularly limited.

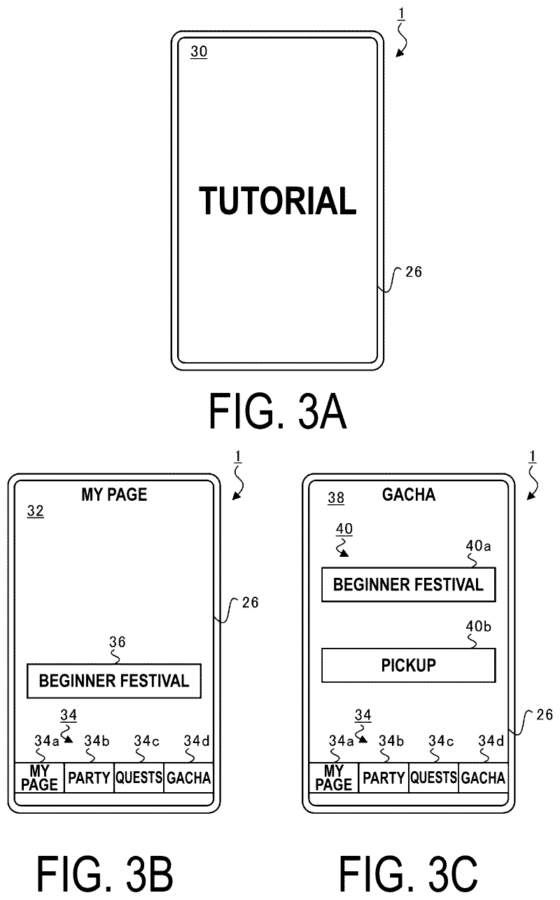

FIG. 3A is a diagram illustrating an example of a tutorial screen 30. When the player activates the game application for the first time, the tutorial screen 30 is displayed. On the tutorial screen 30, a predetermined content (hereinafter referred to as a tutorial) provided when the player plays the game for the first time is executed.

In the tutorial, the player creates a character to be used in the game. In the tutorial, the player views a predetermined video that reflects the world view of the game. In the tutorial, the player receives a brief explanation of the game, such as the story of the game, notes, and control methods. In the tutorial, the player experiences a simple quest (tutorial quest). By experiencing such a tutorial, the player can easily grasp the content of the game even when playing the game for the first time and becomes familiar with the game.

When the tutorial is finished, a my page screen 32 (FIG. 3B) is displayed. FIG. 3B is a diagram illustrating an example of the my page screen 32. The my page screen 32 corresponds to an initial screen, and a menu bar 34 is displayed at the lower portion of the my page screen 32. The menu bar 34 includes a plurality of operation portions that can be operated (tapped) by the player. The menu bar 34 includes a my page screen selection operation portion 34a denoted by “my page”, a party screen selection operation portion 34b denoted by “party”, a quest screen selection operation portion 34c denoted by “quests”, and a gacha screen selection operation portion 34d denoted by “gacha”.

When the my page screen selection operation portion 34a is tapped, the my page screen 32 illustrated in FIG. 3B is displayed on the display 26.

In the game of the present embodiment, a plurality of ally characters are provided. When the player obtains a new ally character via, for example, gacha (lottery) or the like as described below, the ally character ID (possessed game content ID) of the obtained ally character is associated with the player ID of the player.

In the present embodiment, a so-called battle game is provided in which a plurality of ally characters possessed by the player are selected to form a party and fight against an enemy character. When the party screen selection operation portion 34b is tapped, a party screen (not illustrated) is displayed.

Although a detailed description is omitted, on the party screen, a party constituted by ally characters owned by the player is formed and saved. Also, it is possible to equip the ally characters with various types of equipment such as weapons and armors. An additional value for attack power, defense power, and/or the like is set for each piece of equipment. When equipment is equipped, the combat power, such as the life points, attack power, and defense power, of the ally character can be increased.

When the quest screen selection operation portion 34c is tapped, a quest screen (not illustrated) is displayed. Although a detailed description is omitted, on the quest screen, it is possible to select any one of a plurality of types of battle games provided and start the battle game.

When the gacha screen selection operation portion 34d is tapped, a gacha screen 38 (FIG. 3C) is displayed as described below.

FIG. 3C is a diagram illustrating an example of the gacha screen 38. As illustrated in FIG. 3C, a gacha type selection operation portion 40 is displayed on the gacha screen 38. The gacha type selection operation portion 40 displays a gacha type operation portion indicating the gacha type (selection type) currently being held (available).

In the present embodiment, “pickup”, “festival”, and “beginner festival” are provided as the gacha types. In each gacha type, basically, a lottery can be entered by spending in-game currency. In addition, each gacha type is different in terms of the lottery probability (winning probability) of each game content available in the lottery. Further, a period in which a lottery can be executed is set for the gacha type.

Here, the game content includes normal game content, limited edition game content, and festival only game content. The normal game content is game content that can be obtained (won) in all gacha types. The limited edition game content is game content that can be obtained (won) in “pickup”. The festival only game content is game content that can be obtained (won) in “festival” or “beginner festival”. That is, the festival only game content may be game content exclusive to “festival” or “SP festival”.

In addition, a period (hereinafter, referred to as an event period) in which a lottery can be executed is set in advance for each of “pickup”, “festival”, and “beginner festival”. In “pickup”, a predetermined normal game content or limited edition game content is set as the target game content, and the winning probability of the target game content is set to be higher than that of other game content. In addition, in “pickup”, the target game content is changed, for example, every two weeks. Thus, it can be said that “pickup” having different target game contents or event periods means different gacha types.

In “festival”, a predetermined festival only game content is set as the target game content, and the winning probability of the target game content is set to be higher than that of other game content. “festival” is held for three days, for example, instead of “pickup”. Also, it can be said that “festival” having different target game contents or event periods means different gacha types. Note that “festival” may be held in parallel with “pickup”.

“beginner festival” is a gacha for a player who has newly started the game. “beginner festival” is held for a predetermined period from the end of the tutorial. “beginner festival” has the same content as the “festival” near the event period from among the festivals that have already ended.

In the server 100, a lottery table in which the lottery probability of game content is set for each type of gacha, and event period information (information indicating a time period in which the lottery table can be referenced) are stored, and a lottery (gacha) is executed with reference to the lottery table of the selected type of gacha.

As described above, in “festival”, festival only game content can be obtained by lottery. The festival only game content makes it more possible to advantageously progress through the game than the normal game content and the limited edition game content (often, the festival only game content is strong game content). Thus, the player can advantageously progress through the subsequent games (battle games) by executing a “festival” lottery and obtaining festival only game content during the festival event period.

A player who newly starts a game strongly desires to obtain festival only game content in order to advantageously progress through the game. However, the festival only game content can be obtained only during the festival event period. Thus, unless the game is started during a festival event period, the player cannot obtain the festival only game content until the next festival period, and thus, the motivation to play the game may be reduced.

Regarding this, in the present embodiment, a predetermined period (hereinafter, also referred to as a beginner festival event period) in which a “beginner festival” lottery can be executed is set only for a player who newly starts the game and has finished the tutorial. That is, a player who newly starts the game can receive a “beginner festival” lottery during a predetermined period from the time when the progress status of the game becomes a predetermined state.

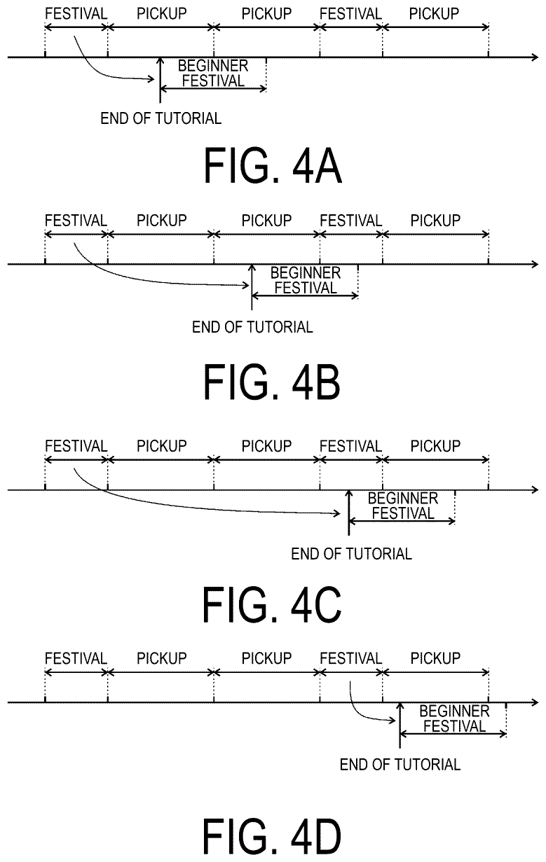

FIGS. 4A to 4D are diagrams for describing the lottery table of “beginner festival”. As illustrated in FIGS. 4A to 4D, in this example, a first “festival”, a first “pickup”, a second “pickup”, a second “festival”, and a third “pickup” are held in order. All of these gachas have different lottery tables.

Then, as illustrated in FIG. 4A, in this example, the tutorial ends when the first “festival” has finished and the first “pickup” is held. In this case, the lottery table of the first “festival” is used for the “beginner festival”. That is, in the “beginner festival”, game content can be obtained at the same lottery probability as in the first “festival”.

Also, as illustrated in FIG. 4B, in this example, the tutorial ends when the first “festival” and the first “pickup” has finished and the second “pickup” is held. In this case, as in the example illustrated in FIG. 4A, the lottery table of the first “festival” is used for the “beginner festival”. That is, in the “beginner festival”, game content can be obtained at the same lottery probability as in the first “festival”.

Also, as illustrated in FIG. 4C, in this example, the tutorial ends when the first “festival”, the first “pickup”, and the second “pickup” has finished and the second “festival” is held. In this case, as in the examples illustrated in FIGS. 4A and 4B, the lottery table of the first “festival” is used for the “beginner festival”. In addition, while the second “festival” is held, both the “festival” and the “beginner festival” are held.

Also, as illustrated in FIG. 4D, in this example, the tutorial ends when the first “festival”, the first “pickup”, the second “pickup”, and the second “festival” have finished and the third “pickup” is held. In this case, the lottery table of the second “festival” is used for the “beginner festival”.

That is, at the time when the tutorial is finished, the “beginner festival” is executed using the lottery table of the previous “festival” that has already finished. More specifically, in the “beginner festival”, the lottery table of the “festival” held most recently among the plurality of festivals is used.

In the “festival”, new festival only game content may be added. The newly added festival only game content makes it more possible to advantageously progress through the game than the other festival only game content (often, the festival only game content is strong game content).

Thus, in the present embodiment, a player who newly starts a game is allowed to play a “beginner festival” with the lottery table of the “festival” that has been held most recently, making it possible to obtain festival only game content for more advantageously progressing through the game. Accordingly, a player who newly starts the game can obtain festival only game content after the end of the tutorial, and thus, it is possible to improve motivation to play the game.

During the beginner festival event period, as illustrated in FIG. 3B, a beginner festival screen selection operation portion 36 denoted by “beginner festival” is displayed above the menu bar 34 on the my page screen 32. During the beginner festival event period, as illustrated in FIG. 3C, a first gacha type operation portion 40a corresponding to “beginner festival” is displayed on the gacha screen 38.

When a second gacha type operation portion 40b is tapped, a pickup gacha screen (not illustrated) corresponding to “pickup” is displayed. Although a detailed description is omitted, the player can enter a lottery based on the lottery table corresponding to “pickup” that is currently being held by spending in-game currency on the pickup gacha screen. In the present embodiment, in “pickup”, the player can execute a so-called ten-pull gacha in which ten lotteries are collectively executed by spending “3000” of the in-game currency.

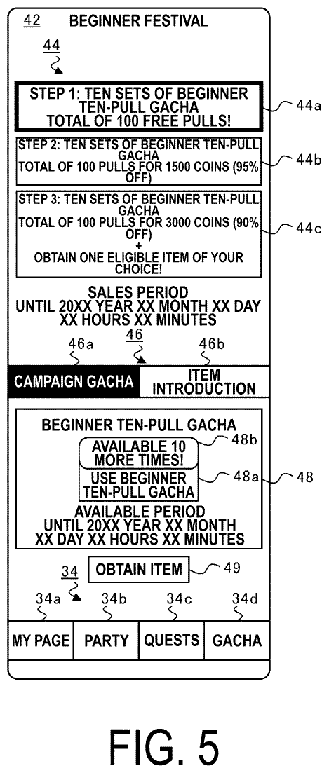

FIG. 5 is a diagram illustrating an example of a beginner festival screen 42 in “STEP 1”. When the beginner festival screen selection operation portion 36 or the first gacha type operation portion 40a is tapped, the beginner festival screen 42 corresponding to “beginner festival” is displayed.

In the present embodiment, in the “beginner festival”, the player can execute a maximum of 30 times of a so-called ten-pull gacha in which ten lotteries are collectively executed, meaning that a lottery can be executed a maximum of 300 times.

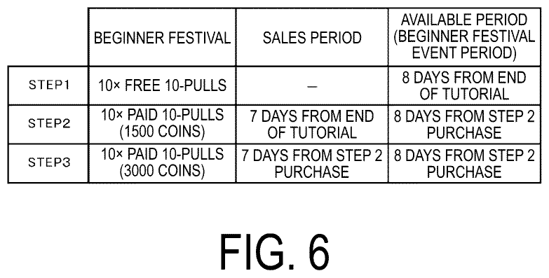

FIG. 6 is a diagram for describing the relationship between a sales period and an available period (the beginner festival event period) in each “STEP” of the “beginner festival”. As illustrated in FIG. 6, in the present embodiment, the “beginner festival” has a plurality of stages (“STEP 1” to “STEP 3”). In “STEP 1”, the player can execute ten-pull gacha ten times without spending in-game currency. In other words, in “STEP 1”, the player can obtain the right to execute ten-pull gacha ten times without spending in-game currency.

In the present embodiment, the available period in which the player has the right to execute ten-pull gacha ten times in “STEP 1” of the “beginner festival” is set to an 8-day period from the end of the tutorial. In the present embodiment, when the ten-pull gacha is executed ten times in “STEP 1”, the end condition of “STEP 1” is satisfied, and the process proceeds to “STEP 2”.

As illustrated in FIG. 6, the player can obtain (purchase) the right to execute ten-pull gacha ten times by spending a predetermined amount of in-game currency (in the present embodiment, “1500” of the in-game currency) in “STEP 2”. As illustrated in FIG. 6, the right to execute ten-pull gacha ten times in “STEP 2” can be purchased in a 7-day period from the end of the tutorial. Also, the available period in which the player has the right to execute ten-pull gacha ten times in “STEP 2” of the “beginner festival” is set to an 8-day period from the time when the right is purchased in “STEP 2”. Then, when the ten-pull gacha is executed ten times in “STEP 2”, the end condition of “STEP 2” is satisfied, and the process proceeds to “STEP 3”.

As described above, the beginner festival event period is initially set to an 8-day period from the end of the tutorial. On the other hand, as described above, in a case where the player purchases the right to execute ten-pull gacha ten times in “STEP 2” of “beginner festival”, the beginner festival event period is set to an 8-day period from the time when the right is purchased in “STEP 2”. That is, when the player purchases the right described above of “STEP 2” of “beginner festival” on the next day after the end of the tutorial, the beginner festival event period is extended in duration.

As illustrated in FIG. 6, the player can obtain (purchase) the right to execute ten-pull gacha ten times by spending a predetermined amount of in-game currency (in the present embodiment, “3000” of the in-game currency) in “STEP 3”. As illustrated in FIG. 6, the right to execute ten-pull gacha ten times in “STEP 3” can be purchased in a 7-day period from the time when the right described above is purchased in “STEP 2”. Also, the available period in which the player has the right to execute ten-pull gacha ten times in “STEP 3” of the “beginner festival” is set to an 8-day period from the time when the right is purchased in “STEP 2”.

In the example described above of the present embodiment, the amount (price) of in-game currency required to purchase the right in “STEP 2” is less than the amount (price) of in-game currency required to purchase the right in “STEP 3”. However, the amount (price) of in-game currency required to purchase the right in “STEP 2” and the amount (price) of in-game currency required to purchase the right in “STEP 3” are not limited to this example.

For example, the amount of in-game currency required to purchase the right in “STEP 2” and the amount of in-game currency required to purchase the right in “STEP 3” may be the same. Also, for example, the amount of in-game currency required to purchase the right in “STEP 2” may be equal to or less than the amount of in-game currency required to purchase the right in “STEP 3”. Also, for example, the amount of in-game currency required to purchase the right in “STEP 2” may be equal to or greater than the amount of in-game currency required to purchase the right in “STEP 3”. Also, the amount of in-game currency required to purchase the right in “STEP 2” and “STEP 3” may be equal to or less than the amount of in-game currency required to execute ten-pull gacha one time in “pickup”.

The specific conditions such as the number of days for the “sales period” and the “available period” illustrated in FIG. 6 are examples and are not limited to the examples described above. The start timing of the “sales period” and the “available period” described above may be determined under any condition as long as it is a timing after the player starts the game (creates a game account ID). Also, the end timing of the “available period” can be set as appropriate under any condition or may not be set. That is, the player may be able to exercise the right to execute ten-pull gacha ten times in each “STEP” of “beginner festival” at any timing.

As illustrated in FIG. 5, a STEP display portion 44 is displayed on the beginner festival screen 42. The STEP display portion 44 is provided with a STEP 1 display portion 44a corresponding to “STEP 1”, a STEP 2 display portion 44b corresponding to “STEP 2”, and a STEP 3 display portion 44c corresponding to “STEP 3”. As illustrated in FIG. 5, in the STEP display portion 44, any one of the STEP 1 display portion 44a to the STEP 3 display portion 44c corresponding to the current STEP is highlighted. In FIG. 5, the current “STEP” is “STEP 1”, and the STEP 1 display portion 44a is highlighted.

When the current “STEP” is “STEP 1”, as illustrated in FIG. 5, a period (sales period) in which the right to execute ten-pull gacha ten times is purchasable in “STEP 2” of “beginner festival” is displayed in the central portion of the beginner festival screen 42. Here, as the sales period, the days and time of seven days from the end of the tutorial is displayed.

As illustrated in FIG. 5, a switching display tab 46 is displayed in the central portion of the beginner festival screen 42. The switching display tab 46 is provided with a first tab 46a denoted by “campaign gacha” and a second tab 46b denoted by “item introduction”. FIG. 5 illustrates a state in which the first tab 46a is selected.

When the first tab 46a of the switching display tab 46 is selected, a gacha display portion 48 and an item obtainment screen operation portion 49 are displayed below the switching display tab 46. An image corresponding to “beginner festival” is displayed in the gacha display portion 48. Further, the gacha display portion 48 displays a beginner festival gacha operation portion 48a corresponding to “beginner festival”. Further, the gacha display portion 48 displays a remaining number of times display portion 48b for communicating the remaining number of times ten-pull gacha can be executed in the current “STEP”.

In the example illustrated in FIG. 5, since the player has not executed ten-pull gacha in “STEP 1”, “available 10 more times!” is displayed in the remaining number of times display portion 48b. Further, the available period of the right to execute ten-pull gacha ten times in the current “STEP” is displayed below the gacha display portion 48. Here, the days and time of eight days from the end of the tutorial is displayed.

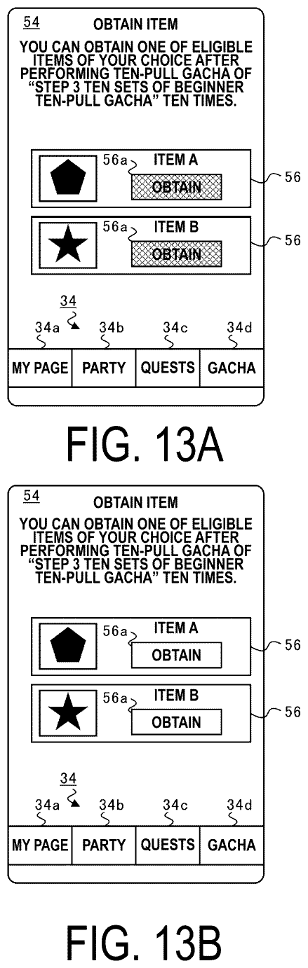

When the item obtainment screen operation portion 49 denoted by “obtain item” is tapped, an item obtainment screen 54 (FIGS. 13A and 13B) described below is displayed.

When the second tab 46b of the switching display tab 46 is selected, an item introduction display portion (not illustrated) is displayed in place of the gacha display portion 48 below the switching display tab 46. The item introduction display portion displays various information about game contents that can be obtained (won) in “beginner festival”.

When the beginner festival gacha operation portion 48a in FIG. 5 is tapped, the server 100 selects a lottery table corresponding to the “beginner festival” currently being held. Then, in the server 100, a consecutive lottery (ten-pull gacha) is executed in which a lottery (hereinafter referred to as an “individual lottery”) for determining a reward to be given to a player is executed ten times with reference to the selected lottery table. That is, the consecutive lottery is executed with ten individual lotteries as one set. In other words, ten individual lotteries are consecutively executed for each consecutive lottery. In the individual lottery, a certain reward is always determined. Thus, the player can obtain ten rewards in one consecutive lottery.

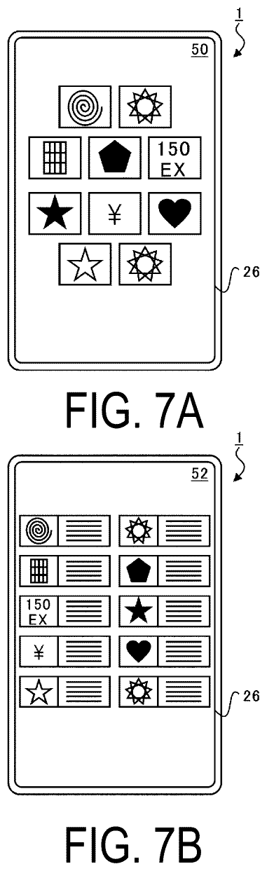

FIG. 7A is a diagram illustrating an example of a lottery result screen 50. The result of the consecutive lottery, that is, the ten rewards given to the player, are displayed on the lottery result screen 50 as illustrated in FIG. 7A. The lottery result screen 50 is a part of the animation of the consecutive lottery.

FIG. 7B is a diagram illustrating an example of a lottery result confirmation screen 52. When the player inputs an operation while the lottery result screen 50 is displayed, the lottery result confirmation screen 52 illustrated in FIG. 7B is displayed. For each reward determined by the individual lottery, a brief description of the corresponding reward is displayed on the lottery result confirmation screen 52.

In the individual lottery, the winning probability of each of a plurality of types (for example, from 30 to 1000 types) of rewards is set in advance. The rewards are roughly classified into four types of “SS rare”, “S rare”, “rare”, and “common” according to the winning probability. Here, the winning probability of “SS rare” is the lowest, and the winning probability becomes higher in the order of “S rare”, “rare”, and “common”. The winning probability of each reward is set for each period. In the present embodiment, the winning ratio of each reward is set to be equal in the ten individual lotteries in one consecutive lottery. However, the winning ratio of each reward may be different in each of the ten individual lotteries. Further, for example, only the winning ratio of a part (for example, the tenth time) of the ten individual lotteries may be different.

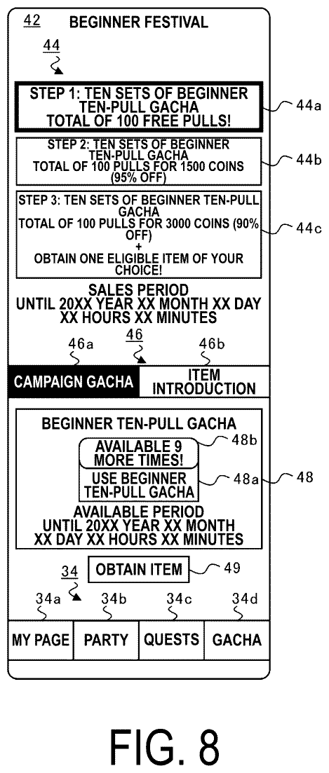

FIG. 8 is a second diagram illustrating an example of the beginner festival screen in “STEP 1”. When a player operation is input while the lottery result confirmation screen 52 is displayed, the display of the lottery result confirmation screen 52 is ended, and the beginner festival screen 42 illustrated in FIG. 8 is displayed. As described above, since ten-pull gacha is executed once in “STEP 1”, the display of the remaining number of times display portion 48b is updated on the beginner festival screen 42 to display “available 9 more times!”.

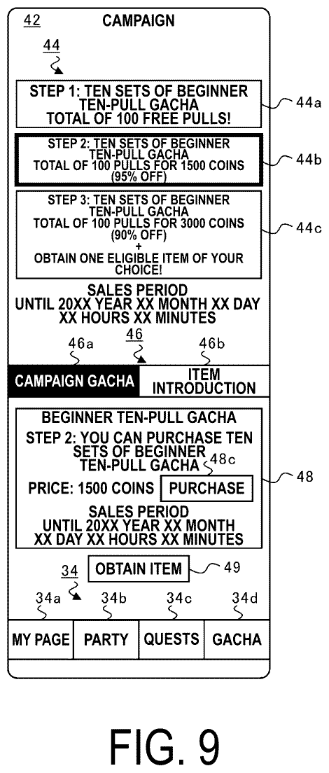

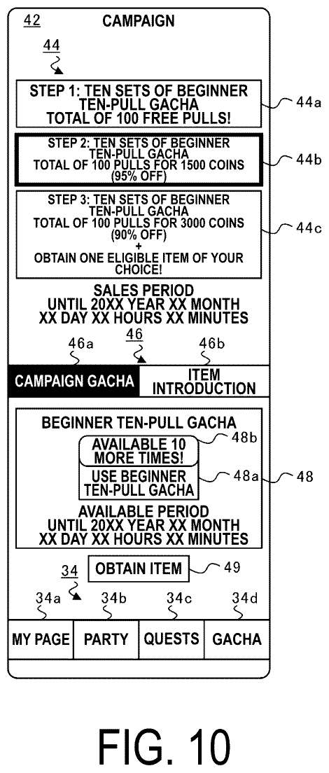

FIG. 9 is a first diagram illustrating an example of the beginner festival screen 42 in “STEP 2”. FIG. 10 is a second diagram illustrating an example of the beginner festival screen 42 in “STEP 2”. When the ten-pull gacha is executed ten times in “STEP 1”, the end condition of “STEP 1” is satisfied, and the process proceeds to “STEP 2”. When the stage is shifted to “STEP 2”, the STEP 2 display portion 44b is highlighted as illustrated in FIG. 9.

As illustrated in FIG. 9, the player can purchase the right to execute ten-pull gacha ten times by spending a predetermined amount of in-game currency (in the present embodiment, “1500” of the in-game currency) in the gacha display portion 48 of the beginner festival screen 42. In other words, in the present embodiment, when the ten-pull gacha is executed ten times in “STEP 1” and the end condition of “STEP 1” is satisfied, the right to execute ten-pull gacha ten times in “STEP 2” can be purchased.

Further, a period (sales period) in which the right to execute ten-pull gacha ten times can be purchased in “STEP 2” is displayed below the gacha display portion 48. Here, as the sales period, the days and time of seven days from the end of the tutorial is displayed.

In addition, a purchase operation portion 48c denoted by “purchase” is displayed in the central portion of the gacha display portion 48. When the purchase operation portion 48c is operated, a predetermined number of in-game currency (in the present embodiment, “1500” of the in-game currency) is spent, and the right to execute ten-pull gacha ten times is associated with the player ID. When the purchase operation portion 48c is operated, a confirmation screen (not illustrated) may be displayed.

The in-game currency includes paid in-game currency and free in-game currency. The paid in-game currency is in-game currency that can be purchased by the player by spending their own assets (real money or assets corresponding to real money). The free in-game currency is in-game currency given by the administrator to the player free of charge. In the present embodiment, only the paid in-game currency can be used to purchase the right to execute ten-pull gacha ten times in “STEP 2” and “STEP 3”.

However, in another example, both the free in-game currency and the paid in-game currency may be used for the purchase of the right in “STEP 2” and “STEP 3”. Also, only the paid in-game currency may be used to purchase the right in “STEP 2”, and only the free in-game currency may be used to purchase the right in “STEP 3”. Also, only the free in-game currency may be used to purchase the right in “STEP 2”, and only the paid in-game currency may be used to purchase the right in “STEP 3”. Also, in another example, a price other than in-game currency may be used for the purchase of the right in “STEP 2” and “STEP 3”. Examples of the price other than in-game currency may be the player's own assets (real money or assets corresponding to real money). As a price other than in-game currency, for example, a player may achieve a task such as viewing a predetermined advertisement.

As described above, when the player purchases the right to execute ten-pull gacha ten times in “STEP 2”, the beginner festival screen 42 is displayed as illustrated in FIG. 10.

At this time, as illustrated in FIG. 10, the gacha display portion 48 displays the beginner festival gacha operation portion 48a and the remaining number of times display portion 48b. In the remaining number of times display portion 48b, “available 10 more times!” is displayed to communicate that the player has been given the right to execute ten-pull gacha ten times in “STEP 2”.

Further, as illustrated in FIG. 10, the available period of the right to execute ten-pull gacha ten times in the current “STEP 2” is displayed below the gacha display portion 48. Here, the days and time of seven days from the time of purchase of the right in “STEP 2” is displayed. When the ten-pull gacha is executed ten times in “STEP 2”, the end condition of “STEP 2” is satisfied, and the process proceeds to “STEP 3”.

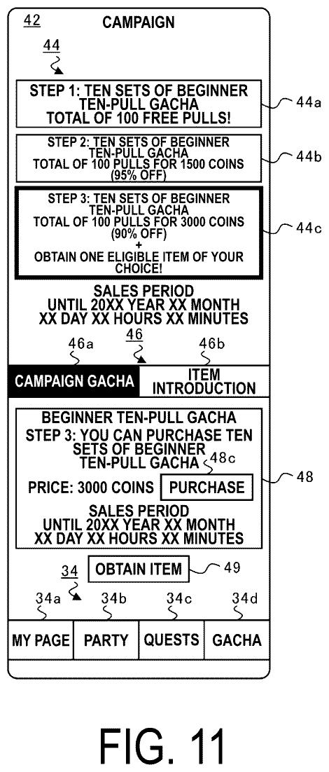

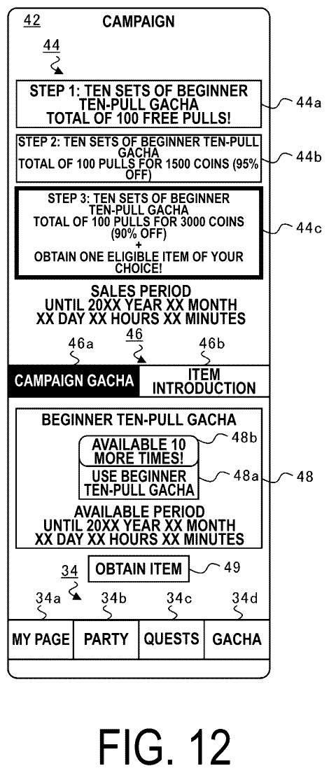

FIG. 11 is a first diagram illustrating an example of the beginner festival screen 42 in “STEP 3”. FIG. 12 is a second diagram illustrating an example of the beginner festival screen 42 in “STEP 3”. When the stage is shifted to “STEP 3”, the STEP 3 display portion 44c is highlighted as illustrated in FIG. 11.

As illustrated in FIG. 11, the player can purchase the right to execute ten-pull gacha ten times by spending a predetermined amount of in-game currency (in the present embodiment, “3000” of the in-game currency) in the gacha display portion 48 of the beginner festival screen 42. In other words, in the present embodiment, when the ten-pull gacha is executed ten times in “STEP 2” and the end condition of “STEP 2” is satisfied, the right to execute ten-pull gacha ten times in “STEP 3” can be purchased.

Further, a period (sales period) in which the right to execute ten-pull gacha ten times can be purchased in “STEP 3” is displayed below the gacha display portion 48. Here, as the sales period, the days and time of seven days from the time of purchase of the right in “STEP 2” is displayed.

In addition, the purchase operation portion 48c denoted by “purchase” is displayed in the central portion of the gacha display portion 48. When the purchase operation portion 48c is operated, a predetermined number of in-game currency (in the present embodiment, “3000” of the in-game currency) is spent, and the right to execute ten-pull gacha ten times is associated with the player ID.

As described above, when the player purchases the right to execute ten-pull gacha ten times in “STEP 3”, the beginner festival screen 42 is displayed as illustrated in FIG. 12.

At this time, as illustrated in FIG. 12, the gacha display portion 48 displays the beginner festival gacha operation portion 48a and the remaining number of times display portion 48b. In the remaining number of times display portion 48b, “available 10 more times!” is displayed to communicate that the player has been given the right to execute ten-pull gacha ten times in “STEP 3”.

Further, as illustrated in FIG. 12, the available period of the right to execute ten-pull gacha ten times in the current “STEP 3” is displayed below the gacha display portion 48. Here, the days and time of seven days from the time of purchase of the right in “STEP 2” is displayed. However, the days and time corresponding to a predetermined period, such as seven days, from the time of purchase of the right in “STEP 3” may be displayed.

In the present embodiment, when ten-pull gacha is executed ten times in “STEP 3”, the item obtainment condition is satisfied, and the item obtainment right is given to the player ID. The item obtainment right is a right to select one desired item (game content) from an obtainable lineup set in advance and obtain the selected item. In the present embodiment, for example, a plurality of items including festival only game content are set in the obtainable lineup.

As described above, when the item obtainment screen operation portion 49 of the beginner festival screen 42 is tapped, the item obtainment screen 54 is displayed.

FIG. 13A is a first diagram illustrating an example of the item obtainment screen 54. FIG. 13B is a second diagram illustrating an example of the item obtainment screen 54. As illustrated in FIG. 13A, a plurality of obtainable lineup display portions 56 are displayed on the item obtainment screen 54. Information indicating the corresponding item is displayed in each obtainable lineup display portion 56. In addition, an obtain operation portion 56a denoted by “obtain” is displayed in each of the obtainable lineup display portions 56.

In a state where the item obtainment right is not given to the player ID, the obtain operation portion 56a is displayed in an inoperable state as illustrated in FIG. 13A. On the other hand, in a state where the item obtainment right is given to the player ID, the obtain operation portion 56a is displayed in an operable state as illustrated in FIG. 13B.

Then, when the obtain operation portion 56a displayed in an operable state is tapped, the item obtainment right is spent, and the corresponding item is given to the player (the game content ID is stored in association with the player ID). Note that when the item obtainment right is spent, the obtain operation portions 56a are displayed in an inoperable state as illustrated in FIG. 13A. That is, in the present embodiment, the item obtainment right is removed when the player taps the obtain operation portion 56a to obtain a desired item once. However, the item obtainment right may be removed when the player taps the obtain operation portion 56a to obtain a desired item a plurality of times.

In the “beginner festival”, every time ten-pull gacha is executed once, 10 points are added as exchange points, and when the total of the exchange points reaches 300 points, the obtain operation portion 56a may be displayed in an operable state.

In addition, when the total of the exchange points is less than 300 points, the item obtainment screen operation portion 49 of the beginner festival screen 42 may be displayed in an inoperable state. In addition, when the total of the exchange points is 300 points, the item obtainment screen operation portion 49 of the beginner festival screen 42 may be displayed in an operable state.

In addition, in “STEP 3”, in a period before ten-pull gacha is executed ten times and the obtainment condition is satisfied, the item obtainment screen operation portion 49 of the beginner festival screen 42 may be displayed in an inoperable state. Then, in “STEP 3”, when ten-pull gacha is executed ten times and the obtainment condition is satisfied, the item obtainment screen operation portion 49 of the beginner festival screen 42 may be displayed in an operable state.

In the present embodiment, when the sales period in each “STEP” of the “beginner festival” has passed, the purchase operation portion 48c becomes inoperable. When the available period in each “STEP” of the “beginner festival” has passed, the beginner festival gacha operation portion 48a becomes inoperable. In this manner, since the “beginner festival” is held in a limited period, the “beginner festival” itself has a rarity value. This makes it possible to motivate a beginner player who wants to advantageously progress through the game to purchase the paid in-game currency, thereby increasing the player's motivation to play the game.

In the present embodiment, as illustrated in FIG. 6, the sales period of the right in “STEP 2” is seven days from the end of the tutorial, while the available period of the right in “STEP 1” is eight days. Accordingly, it is possible to reduce the possibility of the player not using the right in “STEP 2”. This can reduce the possibility of the player losing the right and losing the motivation to play the game.

In the present embodiment, the available period in “STEP 2”, and the available period in “STEP 3” are eight days from the purchase of the right in “STEP 2”. This makes it possible to reduce the possibility of the player not using the right even when the player purchases the right in “STEP 2” immediately before the end of the sales period of the right in “STEP 2”. In other words, the possibility of the player not executing a lottery and becoming less motivated to play the game can be reduced. This can reduce the possibility of the player losing the right and losing the motivation to play the game.

In the present embodiment, as illustrated in FIG. 6, the sales period of the right in “STEP 3” is set to seven days from the purchase of the right in “STEP 2”. That is, when the player purchases the right in “STEP 2” on or after the day after the end of the tutorial, the “sales period” is extended. Accordingly, it is possible to reduce the possibility of the player not purchasing the right in “STEP 3”.

Note that the specific numerical values of the sales period and the available period in FIG. 6 are examples and no such limitation is intended. That is, the sales period of the right in “STEP 2” may be a period (time) equal to or less than the available period of the right in “STEP 1”. The sales period of the right in “STEP 2” may be a period (time) equal to or greater than the available period of the right in “STEP 1”.

The sales period of the right in “STEP 3” may be a period (time) equal to or less than the available period of the right in “STEP 2”. The sales period of the right in “STEP 3” may be a period (time) equal to or greater than the available period of the right in “STEP 2”.

The sales period of the right in “STEP 3” may be a period (time) equal to or less than the available period of the right in “STEP 3”. The sales period of the right in “STEP 3” may be a period (time) equal to or greater than the available period of the right in “STEP 3”.

The sales period of the right in “STEP 2” may be a period (time) that is the same as or different from the sales period of the right in “STEP 3”.

Further, as a remedy for a player who has forgotten to purchase the right within the sales period of each “STEP” of the “beginner festival”, the “beginner festival” may be executed (resumed) again periodically (for example, every other month). In this case, the available period and the sales period of the right in each “STEP” may be shortened.

For example, the available period of the right in “STEP 1” may be three days from the resumption. Further, for example, the sales period of the right in “STEP 2” may be two days from the resumption. Further, for example, the available period of the right in “STEP 2” may be three days from the purchase of the right in “STEP 2”. Further, for example, the sales period of the right in “STEP 3” may be two days from the purchase of the right in “STEP 2”. Further, for example, the available period of the right in “STEP 3” may be three days from the purchase of the right in “STEP 3”.

Next, the basic configuration and communication processing of the player terminal 1 and the server 100 for executing various types of processing associated with the “beginner festival” will be described. Here, examples of basic communication processing of progressing through the “beginner festival” and main communication processing related to the “beginner festival” will be described, and description of other processing will be omitted.

### Functional Configuration of Player Terminal 1

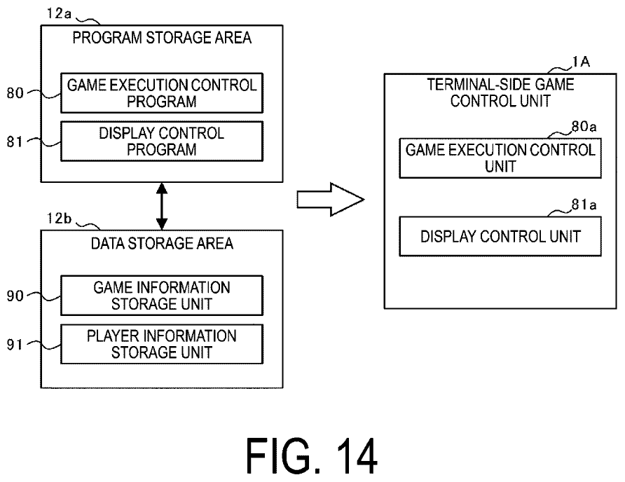

FIG. 14 is a diagram for describing a configuration of the memory 12 in the player terminal 1 and a function as a computer. The memory 12 is provided with a program storage area 12a and a data storage area 12b. When the game is started, the CPU 10 stores a terminal-side game control program (module) in the program storage area 12a.

The terminal-side game control program includes a game execution control program 80 and a display control program 81. Note that the programs listed in FIG. 14 are examples, and many other programs are provided in the terminal-side game control program.

The data storage area 12b is provided with a game information storage unit 90 and a player information storage unit 91 as storage units for storing data. Note that the above-described storage units are merely examples, and many other storage units may be provided in the data storage area 12b.

The CPU 10 operates each program stored in the program storage area 12a and updates the data in each storage unit of the data storage area 12b. Then, the CPU 10 causes the player terminal 1 (computer) to function as a terminal-side game control unit 1A by running each program stored in the program storage area 12a. The terminal-side game control unit 1A includes a game execution control unit 80a and a display control unit 81a.

Specifically, the CPU 10 runs the game execution control program 80 to cause the computer to function as the game execution control unit 80a. Similarly, the CPU 10 operates the display control program 81 to cause the computer to function as the display control unit 81a.

The game execution control unit 80a controls the progress of the entire game. The game execution control unit 80a is responsible for executing the tutorial, for example.

The display control unit 81a generates a screen to be displayed on the display 26 and displays the generated screen on the display 26.

Next, the functional configuration of the server 100 and specific processing in the server 100 will be described. Note that a configuration and processing relating to “beginner festival” will be described below, and other configurations and processing will be omitted.

### Functional Configuration of Server 100

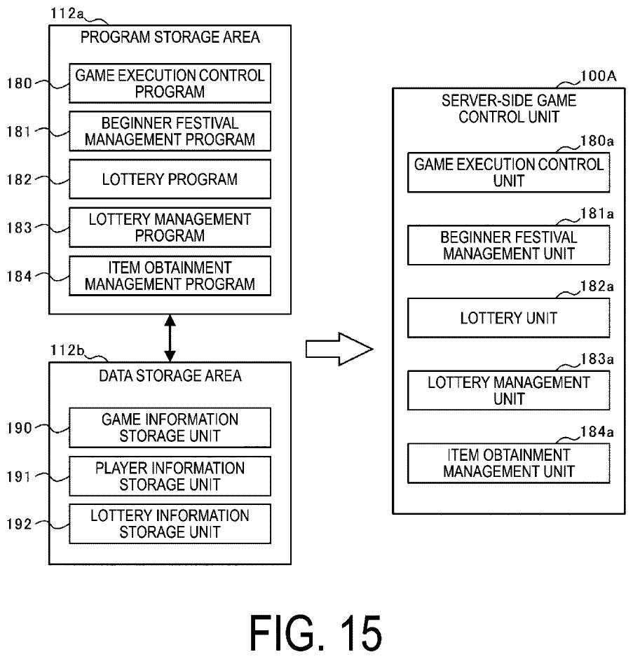

FIG. 15 is a diagram for describing the configuration of the memory 112 in the server 100 and the function as a computer. The memory 112 is provided with a program storage area 112a and a data storage area 112b. When the game is started, the CPU 110 stores a server-side game control program (module) in the program storage area 112a.

The programs stored in the program storage area 112a include a game execution control program 180, a beginner festival management program 181, a lottery program 182, a lottery management program 183, and an item obtainment management program 184. Note that the programs listed in FIG. 15 are examples, and many other programs are provided in the server-side game control program.

The data storage area 112b is provided with a game information storage unit 190, a player information storage unit 191, and a lottery information storage unit 192 as storage units for storing data. Note that the respective storage units described above are merely examples, and many other storage units are provided in the data storage area 112b. These storage units are provided for each player.

The CPU 110 runs each program stored in the program storage area 112a, and updates the data of each storage unit of the data storage area 112b. Then, the CPU 110 causes the server 100 (computer) to function as a server-side game control unit 100A by running each program stored in the program storage area 112a. The server-side game control unit 100A includes a game execution control unit 180a, a beginner festival management unit 181a, a lottery unit 182a, a lottery management unit 183a, and an item obtainment management unit 184a.

Specifically, the CPU 110 runs the game execution control program 180 to cause the computer to function as the game execution control unit 180a. Similarly, the CPU 110 runs the beginner festival management program 181, the lottery program 182, the lottery management program 183, and the item obtainment management program 184 to cause the computer to function as the beginner festival management unit 181a, the lottery unit 182a, the lottery management unit 183a, and the item obtainment management unit 184a, respectively.

The game execution control unit 180a controls the progress of the entire game.

The beginner festival management unit 181a is responsible for controlling the execution of “beginner festival”.

When lottery request information is transmitted from the player terminal 1, the lottery unit 182a references the lottery table selected by the lottery management unit 183a and executes lottery processing, based on the lottery request information.

When lottery request information is transmitted from the player terminal 1, the lottery management unit 183a selects a lottery table based on the lottery request information from the plurality of lottery tables stored in the lottery information storage unit 192, based on the lottery request information. The lottery information storage unit 192 stores lottery tables per gacha type and event period information for each gacha type. When a new gacha type is added, the lottery table of the gacha type and the event period information of the gacha type are stored in the lottery information storage unit 192.

The item obtainment management unit 184a manages the granting and consumption of an item obtainment right that enables a desired item to be obtained from a preset obtainable lineup.

### Communication Processing Between Player Terminal 1 and Server 100

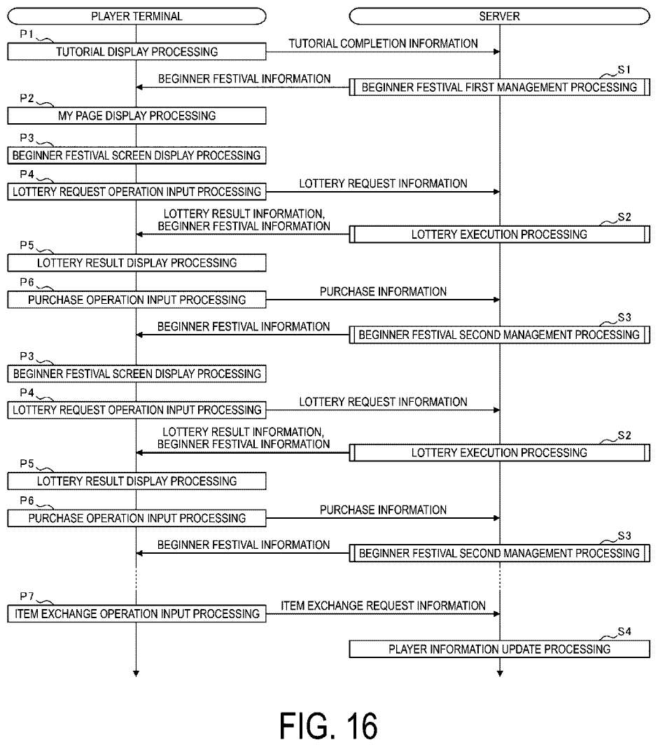

FIG. 16 is a sequence diagram for describing basic processing of the player terminal 1 and the server 100. In the following description, the processing in the player terminal 1 is denoted by Pn (n is any integer). The processing in the server 100 is denoted by Sn (n is any integer).

The player terminal 1 executes tutorial display processing for controlling the execution and display of the tutorial (P1). When the tutorial is finished, the game execution control unit 80a transmits tutorial completion information to the server 100.

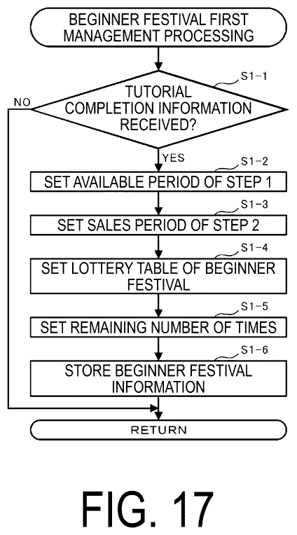

When the tutorial completion information is received, the beginner festival management unit 181a of the server 100 executes beginner festival first management processing (S1). FIG. 17 is a flowchart for describing an example of the beginner festival first management processing in the server 100.

When the tutorial completion information is received (YES in S1-1), based on the relationship illustrated in FIG. 6, the beginner festival management unit 181a of the server 100 performs setting of the available period of the right to execute ten-pull gacha ten times in “STEP 1” of “beginner festival” (S1-2). To be more specific, the beginner festival management unit 181a sets eight days from the end of the tutorial as the available period.

The beginner festival management unit 181a sets a period (sales period) in which the right to execute ten-pull gacha ten times can be purchased in “STEP 2” of “beginner festival” (S1-3), based on the relationship illustrated in FIG. 6. To be more specific, the beginner festival management unit 181a sets seven days from the end of the tutorial as the sales period. However, in the present embodiment, the right can be actually purchased in “STEP 2” within the set sales period and after ten-pull gacha is executed ten times in “STEP 1” and the end condition of “STEP 1” is satisfied.

The lottery management unit 183a of the server 100 selects the lottery table of the “festival” closest to the current time point and sets the selected lottery table as the lottery table of “beginner festival” (S1-4).

The beginner festival management unit 181a sets “10 times” as the remaining number of times information indicating the remaining number of times that ten-pull gacha can be executed in “STEP 1” of “beginner festival” (S1-5). That is, the beginner festival management unit 181a gives the right to execute ten-pull gacha ten times in “STEP 1” of “beginner festival” to the player ID free of charge.

Then, the beginner festival management unit 181a stores the setting contents of the steps S1-1 to S1-5 described above as beginner festival information in the player information storage unit 191 in association with the player ID (S1-6). The beginner festival management unit 181a sets the beginner festival information stored in the player information storage unit 191 so that the player terminal 1 can acquire the beginner festival information.

Returning to FIG. 16, when the display control unit 81a of the player terminal 1 acquires the beginner festival information from the server 100, the display control unit 81a executes my page display processing for displaying the my page screen 32 illustrated in FIG. 3B (P2).

When the beginner festival screen selection operation portion 36 (FIG. 3B) or the first gacha type operation portion 40a (FIG. 3C) is tapped, the display control unit 81a of the player terminal 1 executes beginner festival screen display processing (P3) for displaying the beginner festival screen 42 (FIG. 5).

When the beginner festival gacha operation portion 48a of the beginner festival screen 42 (FIG. 5, 8, 10, or 12) is tapped, the game execution control unit 80a of the player terminal 1 transmits the lottery request information to the server 100 (P4).

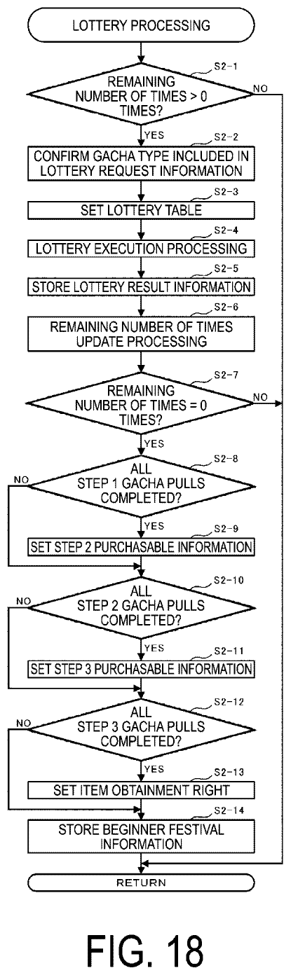

When the lottery request information is received, the server 100 executes lottery processing (S2). FIG. 18 is a flowchart for describing an example of lottery processing in the server 100.

The lottery management unit 183a of the server 100 determines whether the remaining number of times is greater than 0 (S2-1). In a case where the result is that the remaining number of times is greater than 0 (YES in S2-1), the lottery management unit 183a confirms the gacha type included in the lottery request information (S2-2) and sets the lottery table of the confirmed gacha type (S2-3). To be more specific, when the gacha type included in the lottery request information is “beginner festival”, the lottery management unit 183a sets the lottery table set in step S1-4 described above.

Then, the lottery unit 182a refers to the set lottery table, executes lottery execution processing to determine game content by lottery (S2-4), and stores lottery result information indicating the lottery result in the player information storage unit 191 in association with the player ID (S2-5). The lottery unit 182a sets the lottery result information stored in the player information storage unit 191 so that the player terminal 1 can acquire the lottery result information. The lottery result information includes information of the game content (game content ID) determined in the lottery execution processing.

The beginner festival management unit 181a of the server 100 executes remaining number of times update processing of subtracting one from the remaining number of times (S2-6). The beginner festival management unit 181a determines whether the remaining number of times has become 0 as a result of the update in step S2-6 (S2-7). In a case where the result is that the remaining number of times is 0 (S2-7), the beginner festival management unit 181a determines whether ten-pull gacha has been executed ten times in total in “STEP 1” (S2-8). In a case where the result is that ten-pull gacha has been executed ten times in total in “STEP 1” (YES in S2-8), the beginner festival management unit 181a sets STEP 2 purchasable information that enables the right to execute ten-pull gacha ten times to be purchased in “STEP 2” (S2-9). In other words, when the ten-pull gacha is executed ten times in “STEP 1” and the end condition of “STEP 1” is satisfied, the beginner festival management unit 181a makes the right to execute ten-pull gacha ten times purchasable in “STEP 2”.

Also, the beginner festival management unit 181a determines whether ten-pull gacha has been executed ten times in total in “STEP 2” (S2-10). In a case where the result is that ten-pull gacha has been executed ten times in total in “STEP 2” (YES in S2-10), the beginner festival management unit 181a sets STEP 3 purchasable information that enables the right to execute ten-pull gacha ten times to be purchased in “STEP 3” (S2-11). In other words, when the ten-pull gacha is executed ten times in “STEP 2” and the end condition of “STEP 2” is satisfied, the beginner festival management unit 181a makes the right to execute ten-pull gacha ten times purchasable in “STEP 3”.

Also, the beginner festival management unit 181a determines whether ten-pull gacha has been executed ten times in total in “STEP 3” (S2-12). In a case where the result is that ten-pull gacha has been executed ten times in total in “STEP 3” (YES in S2-12), the beginner festival management unit 181a gives the item obtainment right to the player ID (S2-13). That is, the beginner festival management unit 181a gives the item obtainment right to the player ID if ten-pull gacha has been executed ten times and the obtainment condition has been satisfied in “STEP 3”.

The beginner festival management unit 181a stores the setting contents of the steps S2-6, S2-9, S2-11, and S2-13 described above as beginner festival information in the player information storage unit 191 in association with the player ID (S2-14). The beginner festival management unit 181a sets the beginner festival information stored in the player information storage unit 191 so that the player terminal 1 can acquire the beginner festival information.

Returning to FIG. 16, when display control unit 81a of the player terminal 1 acquires the lottery result information from the server 100, the display control unit 81a executes lottery result display processing for displaying the lottery result screen 50 (FIG. 7A) and the lottery result confirmation screen 52 (FIG. 7B) (P5).

When the purchase operation portion 48c of the beginner festival screen 42 (FIG. 9 or 11) is tapped, the game execution control unit 80a of the player terminal 1 transmits the purchase information to the server 100 (P6). When the purchase operation portion 48c of the beginner festival screen 42 (FIG. 9) is tapped, the game execution control unit 80a transmits the purchase information (STEP 2) to the server 100 as the purchase information. When the purchase operation portion 48c of the beginner festival screen 42 (FIG. 11) is tapped, the game execution control unit 80a transmits the purchase information (STEP 3) to the server 100 as the purchase information.

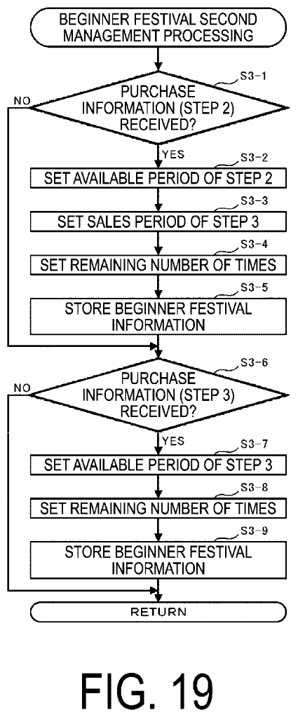

When the server 100 receives the purchase information, the server 100 executes beginner festival second management processing (S3). FIG. 19 is a flowchart for describing an example of the beginner festival second management processing in the server 100.

When the purchase information (STEP 2) is received (YES in S3-1), based on the relationship illustrated in FIG. 6, the beginner festival management unit 181a of the server 100 performs setting of the available period of the right to execute ten-pull gacha ten times in “STEP 2” of “beginner festival” (S3-2). To be more specific, the beginner festival management unit 181a sets eight days from the current time as the available period.

The beginner festival management unit 181a sets a period (sales period) in which the right to execute ten-pull gacha ten times can be purchased in “STEP 3” of “beginner festival” (S3-3), based on the relationship illustrated in FIG. 6. To be more specific, the beginner festival management unit 181a sets seven days from the current time as the sales period. However, in the present embodiment, the right can be actually purchased in “STEP 3” within the set sales period and after ten-pull gacha is executed ten times in “STEP 2” and the end condition of “STEP 2” is satisfied.

The beginner festival management unit 181a sets “10 times” as the remaining number of times information indicating the remaining number of times that ten-pull gacha can be executed in “STEP 2” of “beginner festival” (S3-4). That is, the beginner festival management unit 181a gives the right to execute ten-pull gacha ten times in “STEP 2” of “beginner festival” to the player ID. The beginner festival management unit 181a also executes processing of spending a predetermined amount of in-game currency, specifically, in the present embodiment, “1500” of the in-game currency, from the in-game currency possessed by the player.

Then, the beginner festival management unit 181a stores the setting contents of the steps S3-2 to S3-4 described above as beginner festival information in the player information storage unit 191 in association with the player ID (S3-5). The beginner festival management unit 181a sets the beginner festival information stored in the player information storage unit 191 so that the player terminal 1 can acquire the beginner festival information.

When the purchase information (STEP 3) is received (YES in S3-6), based on the relationship illustrated in FIG. 6, the beginner festival management unit 181a of the server 100 performs setting of the available period of the right to execute ten-pull gacha ten times in “STEP 3” of “beginner festival” (S3-7). To be more specific, the beginner festival management unit 181a sets eight days from the time of purchase of the right in “STEP 2” as the available period.

The beginner festival management unit 181a sets “10 times” as the remaining number of times information indicating the remaining number of times that ten-pull gacha can be executed in “STEP 3” of “beginner festival” (S3-8). That is, the beginner festival management unit 181a gives the right to execute ten-pull gacha ten times in “STEP 3” of “beginner festival” to the player ID. The beginner festival management unit 181a also executes processing of spending a predetermined amount of in-game currency, specifically, in the present embodiment, “3000” of the in-game currency, from the in-game currency possessed by the player.

Then, the beginner festival management unit 181a stores the setting contents of the steps S3-7 to S3-8 described above as beginner festival information in the player information storage unit 191 in association with the player ID (S3-9). The beginner festival management unit 181a sets the beginner festival information stored in the player information storage unit 191 so that the player terminal 1 can acquire the beginner festival information.

Referring back to FIG. 16, when the player terminal 1 acquires the beginner festival information from the server 100, the player terminal 1 repeatedly executes the processing of steps P3 to P6 described above. The server 100 repeatedly executes the processing of steps S2 to S3 described above.

When the obtain operation portion 56a displayed in an operable manner on the item obtainment screen 54 (FIG. 13B) is tapped, the game execution control unit 80a of the player terminal 1 transmits item exchange request information to the server 100 (P7).

When the item obtainment management unit 184a of the server 100 receives the item exchange request information, the item obtainment management unit 184a executes player information update processing (S4). Specifically, the item obtainment management unit 184a spends the item obtainment right given to the player ID and gives the item corresponding to the tapped obtain operation portion 56a to the player (the game content ID is stored in association with the player ID).

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it is to be understood that such modifications and corrections also obviously fall within the technical scope of the present disclosure.

In the example of the present embodiment described above, when the ten-pull gacha is executed ten times in “STEP 1” of “beginner festival”, the right to execute ten-pull gacha ten times in “STEP 2” can be purchased. Also in the example described above, when the ten-pull gacha is executed ten times in “STEP 2”, the right to execute ten-pull gacha ten times in “STEP 3” can be purchased. However, the present disclosure is not limited to this, and the right to execute ten-pull gacha ten times in “STEP 2” and “STEP 3” may be purchasable before ten-pull gacha is executed ten times in “STEP 1”.

In the embodiment described above, a common lottery table is used in each “STEP”, but the present disclosure is not limited to this. For example, in each “STEP”, a common lottery table in which the winning probabilities of at least some or all of the game content are different may be used. For example, a lottery table may be used in which the winning probability of the festival only game content is higher in “STEP 2” than in “STEP 1”. Also, a lottery table may be used in which the winning probability of the festival only game content is higher in “STEP 3” than in “STEP 2”.

In any case, an information processing program may cause one or more computers to execute the following processing.

### Processing Executed by Computer

Processing of setting a first period (in this embodiment, for example, the sales period of “STEP 2”) in a case where a predetermined condition (in this embodiment, for example, the tutorial being finished) is satisfied (in this embodiment, for example, steps S1-3).

Processing of enabling reception of a first operation (in this embodiment, for example, a purchase operation input of “STEP 2”) for acquiring a right (in this embodiment, for example, the right to execute ten-pull gacha ten times in “STEP 2”) to obtain a first prize (in this embodiment, for example, game content) by spending a price (in this embodiment, for example, in-game currency) in the first period (in this embodiment, for example, the sales period of “STEP 2”) (in this embodiment, for example, step S2-9).

Processing of giving the first prize (in this embodiment, for example, game content) to a player ID, based on a predetermined operation (in this embodiment, for example, a lottery request operation input) being input, after the right (in this embodiment, for example, the right to execute ten-pull gacha ten times in “STEP 2”) to obtain the first prize (in this embodiment, for example, game content) has been acquired (in this embodiment, for example, steps S2-1 to S2-6 and steps S3-1 to S3-5).

Processing of setting (in this embodiment, for example, step S3-3) a second period (in this embodiment, for example, the sales period of “STEP 3”), based on the right (in this embodiment, for example, the right to execute ten-pull gacha ten times in “STEP 2”) to obtain the first prize (in this embodiment, for example, game content) being acquired.

Processing of enabling reception of a second operation (in this embodiment, for example, a purchase operation input of “STEP 3”) for acquiring a right (in this embodiment, for example, the right to execute ten-pull gacha ten times in “STEP 3”) to obtain a second prize (in this embodiment, for example, game content) identical to or different from the first prize (in this embodiment, for example, game content) by spending a price (in this embodiment, for example, in-game currency) in the second period (in this embodiment, for example, the sales period of “STEP 3”) (in this embodiment, for example, step S2-11).

Processing of giving the second prize (in this embodiment, for example, game content) to a player ID, based on a predetermined operation (in this embodiment, for example, a lottery request operation input) being input, after the right (in this embodiment, for example, the right to execute ten-pull gacha ten times in “STEP 3”) to obtain the second prize (in this embodiment, for example, game content) has been acquired (in this embodiment, for example, steps S2-1 to S2-6 and steps S3-6 to S3-9).

Also, a computer may be caused to execute processing of giving a right (in this embodiment, for example, the right to execute ten-pull gacha ten times in “STEP 1”) to obtain an initial prize (in this embodiment, for example, game content) identical to or different from the first prize (in this embodiment, for example, game content) without spending a price (in this embodiment, for example, in-game currency) to the player ID in the first period (in this embodiment, for example, at least the sales period of “STEP 2”) (in this embodiment, for example, steps S1-1 to S1-6).

A computer may be caused to execute processing of giving the initial prize (in this embodiment, for example, game content) to the player ID by exercising the right (in this embodiment, for example, the right to execute ten-pull gacha ten times in “STEP 1”) to obtain the initial prize (in this embodiment, for example, game content) (in this embodiment, for example, steps S2-1 to S2-6).

The processing of enabling reception of the first operation (in this embodiment, for example, a purchase operation input of “STEP 2”) includes enabling reception of the first operation (in this embodiment, for example, a purchase operation input of “STEP 2”), based on the right (in this embodiment, for example, the right to execute ten-pull gacha ten times in “STEP 1”) to obtain the initial prize (in this embodiment, for example, game content) being exercised (in this embodiment, for example, step S2-8 and step S2-9).

In the embodiment described above, the initial prize, the first prize, and the second prize are all given to the player ID, based on the lottery result of the gacha, but the present disclosure is not limited thereto. That is, in-game currency may be spent to purchase a certain game content (the initial prize, the first prize, and the second prize).

A computer may be caused to execute processing of selecting a selection type most recently executed from among a plurality of selection types (in this embodiment, for example, “festival” gacha types) previously executed (in this embodiment, for example, step S1-4 and steps S2-2 to S2-3).

A computer may be caused to execute processing of referencing a determination table corresponding to the selected selection type and determining one from among a plurality of types of prizes via lottery (in this embodiment, for example, steps S2-3 to S2-5).

Further, a prize determined via the lottery is given to the player ID as the initial prize, the first prize, or the second prize (in this embodiment, for example, step S2-5).

The predetermined condition may include a progress status of a game becoming a predetermined status (in this embodiment, for example, when the tutorial is finished). However, the case where the progress status of a game becoming a predetermined status is not limited to the example described above. For example, when a player logs in to a game in a preset period, the progress status of the game may become the predetermined status. In addition, in a preset battle game, when a player wins, the progress status of the game may become the predetermined status. In addition, when the player obtains (possesses) a preset game content, the progress status of the game may become the predetermined status.

In the above-described embodiment, the information processing system S, which is a client server system, performs the above-described information processing. However, the function of the server 100 in the above-described embodiment may be provided in the player terminal 1. In this case, the communication function is not required, and the player terminal 1 functions as a game terminal device. Only the server 100 in the embodiment described above may be provided as a server device.

The program according to the above-described embodiment and modified example may be stored in a non-transitory computer-readable storage medium and provided as a storage medium. Furthermore, a game terminal apparatus or server apparatus including the storage medium may be provided. In addition, the above-described embodiment and modified example may correspond to an information processing method for implementing each function and the steps illustrated in the flowcharts.

What is claimed is:

1. A non-transitory computer readable medium storing a program that causes a computer to execute:
processing of setting a first period in a case where a predetermined condition is satisfied;
processing of enabling reception of a first operation for acquiring a right to obtain a first prize by spending a price in the first period;
processing of giving the first prize to a player ID, based on a predetermined operation being input, after the right to obtain the first prize has been acquired;
processing of setting a second period, based on the right to obtain the first prize being acquired;
processing of enabling reception of a second operation for acquiring a right to obtain a second prize identical to or different from the first prize by spending a price in the second period; and
processing of giving the second prize to the player ID, based on a predetermined operation being input, after the right to obtain the second prize has been acquired.

2. The non-transitory computer readable medium according to claim 1, wherein the program causes a computer to execute:
processing of giving a right to obtain an initial prize identical to or different from the first prize without spending a price to the player ID in the first period; and
processing of giving the initial prize to the player ID by exercising the right to obtain the initial prize,
wherein
the processing of enabling reception of the first operation includes enabling reception of the first operation, based on the right to obtain the initial prize being exercised.

3. The non-transitory computer readable medium according to claim 2, wherein the program causes a computer to execute:
processing of selecting a selection type most recently executed from among a plurality of selection types previously executed; and
processing of referencing a determination table corresponding to the selected selection type and determining one from among a plurality of types of prizes via lottery, wherein
a prize determined via the lottery is given to the player ID as the initial prize, the first prize, or the second prize.

4. The non-transitory computer readable medium according to claim 1, wherein
the predetermined condition includes a progress status of a game becoming a predetermined status.

5. A game apparatus implemented by one or more computers, the one or more computers executing:
processing of setting a first period in a case where a predetermined condition is satisfied;
processing of enabling reception of a first operation for acquiring a right to obtain a first prize by spending a price in the first period;
processing of giving the first prize to a player ID, based on a predetermined operation being input, after the right to obtain the first prize has been acquired;
processing of setting a second period, based on the right to obtain the first prize being acquired;
processing of enabling reception of a second operation for acquiring a right to obtain a second prize identical to or different from the first prize by spending a price in the second period; and
processing of giving the second prize to the player ID, based on a predetermined operation being input, after the right to obtain the second prize has been acquired.

6. An information processing method implemented by one or more computers, the one or more computers executing:
processing of setting a first period in a case where a predetermined condition is satisfied;
processing of enabling reception of a first operation for acquiring a right to obtain a first prize by spending a price in the first period;
processing of giving the first prize to a player ID, based on a predetermined operation being input, after the right to obtain the first prize has been acquired;
processing of setting a second period, based on the right to obtain the first prize being acquired;
processing of enabling reception of a second operation for acquiring a right to obtain a second prize identical to or different from the first prize by spending a price in the second period; and
processing of giving the second prize to the player ID, based on a predetermined operation being input, after the right to obtain the second prize has been acquired.
